(19) United States
(12) Patent Application Publication
(10) Pub. No.: US 2019/0188243 A1
(43) Pub. Date: Jun. 20, 2019

(54) DISTRIBUTION-LEVEL FEATURE MONITORING AND CONSISTENCY REPORTING

(71) Applicant: Microsoft Technology Licensing, LLC, Redmond, WA (US)

(72) Inventors: Chen Sun, State College, PA (US); David J. Stein, Mountain View, CA (US); Ke Wu, Sunnyvale, CA (US); Joel D. Young, Milpitas, CA (US)

(73) Assignee: Microsoft Technology Licensing, LLC, Redmond, WA (US)

(21) Appl. No.: 15/844,861

(22) Filed: Dec. 18, 2017

(51) Int. Cl. G06F 17/18; G06F 7/02; G06K 9/62; G06F 17/30

(52) U.S. Cl. CPC G06F 17/18; G06F 7/02; G06K 9/6232; G06F 17/30958; G06K 9/6212

(57) ABSTRACT

The disclosed embodiments provide a system for processing data. During operation, the system obtains a set of values and a set of reference values for one or more features used with one or more statistical models. Next, the system applies a hypothesis test to the set of values and the set of reference values to assess a distribution-level consistency in the one or more features. The system then outputs the distribution-level consistency for use in monitoring the distribution of the one or more features. Finally, the system includes, with the outputted distribution-level consistency, one or more factors that contribute to the distribution-level consistency.

### RELATED APPLICATION

The subject matter of this application is related to the subject matter in a co-pending non-provisional application by inventors David J. Stein, Xu Miao, Lance Wall, Joel D. Young, Eric Huang, Songxiang Gu, Da Teng, Chang-Ming Tsai and Sumit Rangwala, entitled “Common Feature Protocol for Collaborative Machine Learning,” having Ser. No. 15/046,199, and filing date 17 Feb. 2016 (Attorney Docket No. LI-P1716.LNK.US).

### BACKGROUND

### Field

The disclosed embodiments relate to data analysis. More specifically, the disclosed embodiments relate to techniques for performing distribution-level feature data monitoring and reporting for data consistency.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of statistical models. The discovered information may then be used to guide decisions and/or perform actions related to the data. For example, the output of a statistical model may be used to guide marketing decisions, assess risk, detect fraud, predict behavior, and/or customize or optimize use of an application or website.

However, significant time, effort, and overhead may be spent on feature selection during creation and training of statistical models for analytics. For example, a data set for a statistical model may have thousands to millions of features, including features that are created from combinations of other features, while only a fraction of the features and/or combinations may be relevant and/or important to the statistical model. For each individual feature, there may be millions to billions of data points. At the same time, training and/or execution of statistical models with large numbers of features typically require more memory, computational resources, and time than those of statistical models with smaller numbers of features.

Additional overhead and complexity may be incurred during sharing and organizing of feature sets. For example, a set of features may be shared across projects, teams, or usage contexts by denormalizing and duplicating the features in separate feature repositories for offline and online execution environments. As a result, the duplicated features may occupy significant storage resources and require synchronization across the repositories. Each team that uses the features may further incur the overhead of manually identifying features that are relevant to the team's operation from a much larger list of features for all of the teams.

Consequently, creation and use of statistical models in analytics may be facilitated by mechanisms for improving the monitoring, management, sharing, and reuse of features among the statistical models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows an exemplary screenshot in accordance with the disclosed embodiments.

FIG. 4 shows a flowchart illustrating a process of performing distribution-level feature monitoring and reporting in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

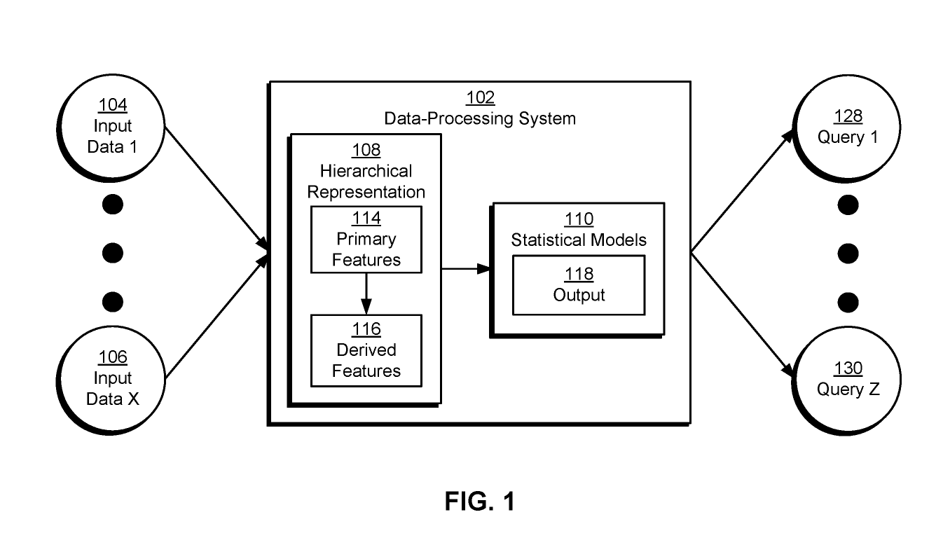

The disclosed embodiments provide a method, apparatus, and system for processing data. As shown in FIG. 1, the system includes a data-processing system 102 that analyzes one or more sets of input data (e.g., input data 1 104, input data x 106). For example, data-processing system 102 may create and train one or more statistical models 110 for analyzing input data related to users, organizations, applications, job postings, purchases, electronic devices, websites, content, sensor measurements, and/or other categories. The statistical models may include, but are not limited to, regression models, artificial neural networks, support vector machines, decision trees, naïve Bayes classifiers, Bayesian networks, deep learning models, hierarchical models, and/or ensemble models.

In turn, the results of such analysis may be used to discover relationships, patterns, and/or trends in the data; gain insights from the input data; and/or guide decisions or actions related to the data. For example, data-processing system 102 may use the statistical models to generate output 118 that includes scores, classifications, recommendations, estimates, predictions, and/or other properties. Output 118 may be inferred or extracted from primary features 114 in the input data and/or derived features 116 that are generated from primary features 114 and/or other derived features. For example, primary features 114 may include profile data, user activity, sensor data, and/or other data that is extracted directly from fields or records in the input data. The primary features 114 may be aggregated, scaled, combined, and/or otherwise transformed to produce derived features 116, which in turn may be further combined or transformed with one another and/or the primary features to generate additional derived features. After output 118 is generated from one or more sets of primary and/or derived features, output 118 is provided in responses to queries (e.g., query 1 128, query z 130) of data-processing system 102. In turn, the queried output 118 may improve revenue, interaction with the users and/or organizations, use of the applications and/or content, and/or other metrics associated with the input data.

In one or more embodiments, data-processing system 102 uses a hierarchical representation 108 of features 114 and derived features 116 to organize the sharing, production, and use of the features across different teams, execution environments, and/or projects. Hierarchical representation 108 may include a directed acyclic graph (DAG) that defines a set of namespaces for primary features 114 and derived features 116. The namespaces may disambiguate among features with similar names or definitions from different usage contexts or execution environments. Hierarchical representation 108 may include additional information that can be used to locate primary features 114 in different execution environments, calculate derived features 116 from the primary features and/or other derived features, and track the development of statistical models or applications that accept the derived features as input.

Consequently, data-processing system 102 may implement, in hierarchical representation 108, a common feature protocol that describes a feature set in a centralized and structured manner, which in turn can be used to coordinate large-scale collaborative machine learning across multiple entities and statistical models. Common feature protocols for large-scale collaborative machine learning are described in a co-pending non-provisional application by inventors David J. Stein, Xu Miao, Lance Wall, Joel D. Young, Eric Huang, Songxiang Gu, Da Teng, Chang-Ming Tsai and Sumit Rangwala, entitled “Common Feature Protocol for Collaborative Machine Learning,” having Ser. No. 15/046,199, and filing date 17 Feb. 2016 (Attorney Docket No. LI-P1716.LNK.US), which is incorporated herein by reference.

In one or more embodiments, features 114 and/or derived features 116 are obtained and/or used with an online professional network or other community of users that is used by a set of entities to interact with one another in a professional, social, and/or business context. The entities may include users that use the online professional network to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

As a result, features 114 and/or derived features 116 may include member features, company features, and/or job features. The member features include attributes from the members' profiles with the online professional network, such as each member's title, skills, work experience, education, seniority, industry, location, and/or profile completeness. The member features also include each member's number of connections in the social network, the member's tenure on the social network, and/or other metrics related to the member's overall interaction or “footprint” in the online professional network. The member features further include attributes that are specific to one or more features of the online professional network, such as a classification of the member as a job seeker or non-job-seeker.

The member features may also characterize the activity of the members with the online professional network. For example, the member features may include an activity level of each member, which may be binary (e.g., dormant or active) or calculated by aggregating different types of activities into an overall activity count and/or a bucketized activity score. The member features may also include attributes (e.g., activity frequency, dormancy, total number of user actions, average number of user actions, etc.) related to specific types of social or online professional network activity, such as messaging activity (e.g., sending messages within the social network), publishing activity (e.g., publishing posts or articles in the social network), mobile activity (e.g., accessing the social network through a mobile device), job search activity (e.g., job searches, page views for job listings, job applications, etc.), and/or email activity (e.g., accessing the social network through email or email notifications).

The company features include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features may relate to behavior or spending with a number of products, such as recruiting, sales, marketing, advertising, and/or educational technology solutions offered by or through the online professional network. For example, the company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within the online professional network.

The company features may also represent a company's level of engagement with and/or presence on the online professional network. For example, the company features may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, recruiting, executive, etc.) who are members of the online professional network. The company features may also include the number of online professional network members at the company with connections to employees of the online professional network, the number of connections among employees in the company, and/or the number of followers of the company in the online professional network. The company features may further track visits to the online professional network from employees of the company, such as the number of employees at the company who have visited the online professional network over a recent period (e.g., the last 30 days) and/or the same number of visitors divided by the total number of online professional network members at the company.

One or more company features may additionally be derived features 116 that are generated from member features. For example, the company features may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, the company features may be used to glean company-level insights or trends from member-level online professional network data, perform statistical inference at the company and/or member segment level, and/or guide decisions related to business-to-business (B2B) marketing or sales activities.

The job features describe and/or relate to job listings and/or job recommendations within the online professional network. For example, the job features may include declared or inferred attributes of a job, such as the job's title, industry, seniority, desired skill and experience, salary range, and/or location. One or more job features may also be derived features 116 that are generated from member features and/or company features. For example, the job features may provide a context of each member's impression of a job listing or job description. The context may include a time and location (e.g., geographic location, application, website, web page, etc.) at which the job listing or description is viewed by the member. In another example, some job features may be calculated as cross products, cosine similarities, statistics, and/or other combinations, aggregations, scaling, and/or transformations of member features, company features, and/or other job features.

Those skilled in the art will appreciate that performance of statistical models 110 may deviate or degrade as the distribution, availability, presence, and/or quality of features inputted into statistical models 110 change over time. For example, the performance of a statistical model may drop in response to a drift in the distribution of features inputted into the statistical model, a change in the source of the features, and/or errors associated with generating the features. Such degraded or suboptimal performance in statistical models 110 may negatively impact the accuracy of results associated with queries of data-processing system and/or subsequent user experiences with applications that use the results.

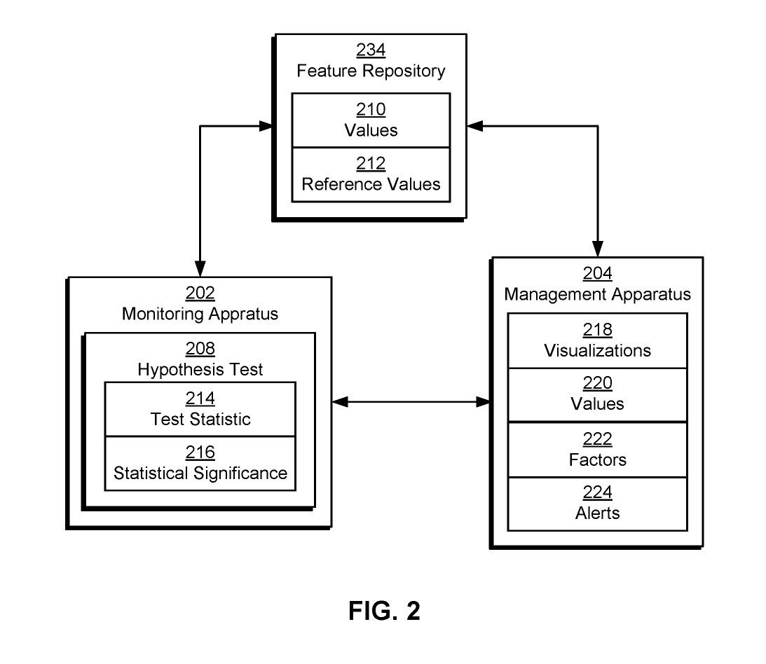

In one or more embodiments, data-processing system 102 performs distribution-level monitoring and reporting of member features, company features, job features, and/or other types of features associated with the input data. As shown in FIG. 2, a system for processing data (e.g., data-processing system 102 of FIG. 1) may include a monitoring apparatus 202 and a management apparatus 204. Each of these components is described in further detail below.

Monitoring apparatus 202 assesses the distribution-level consistency of features (e.g., primary features 114 and/or derived features 116 of FIG. 1) used with one or more statistical models (e.g., statistical models 110 of FIG. 1). In particular, monitoring apparatus 202 determines, for each feature or group of features to be monitored, the consistency of the distribution of a set of values 210 for the feature(s) with respect to a corresponding set of reference values 212 for the feature(s). In other words, the distribution of reference values 212 may be used as a baseline or standard against which the distribution of values 210 is compared to determine if the corresponding feature(s) have changed or are anomalous.

To analyze the distribution-level consistency of a feature, monitoring apparatus 202 obtains values 210 and reference values 212 for the feature from a feature repository 234. For example, feature repository 234 may include a relational database, graph database, data warehouse, filesystem, collection of files, cloud storage, and/or other data store. Values 210 and/or reference values 212 may be loaded and/or stored in feature repository 234 in an online, nearline, and/or offline basis.

Values 210 and reference values 212 may be selected to perform different types of monitoring and/or analysis associated with features in feature repository 234. For example, reference values 212 may be obtained from training data for a statistical model, and values 210 may be obtained from unseen data (e.g., testing data, validation data, production data, etc.) for the statistical model. As a result, the distributions of values 210 and reference values 212 may be compared to verify that the training data and unseen data are consistent.

In another example, reference values 212 may be obtained from one source (e.g., an offline data store), and values 210 may be obtained from a different source (e.g., an online data store and/or real-time or nearline user input). In turn, the distributions of values 210 and reference values 212 may be compared to monitor the consistency of features across platforms.

In a third example, values 210 are obtained from a given time interval (e.g., the most recent hour, day, week, etc.), and reference values 212 are obtained from a preceding time interval (e.g., the previous hour, day, week, etc.). Values 210 and reference values 212 may thus be compared to detect drift and/or other temporal changes or anomalies in the distribution of the corresponding features.

Time intervals from which values 210 and reference values 212 are obtained may be selected and/or adjusted to account for and/or detect trends, seasonal components, cyclical components, and/or irregular components in the distributions of the corresponding features. Continuing with the example, values 210 and reference values 212 may be set (e.g., by a user) to span a day, week, month, and/or other period to compare changes to the features over the period. The period may be shortened to detect short-term or sudden fluctuations in the distribution of the features or lengthened to smooth out day-to-day changes and reduce the effect of seasonal or cyclical components in comparing the distributions of values 210 and reference values 212. The period may reflect the periodicity of seasonal patterns in the features. The period may also be extended to detect long-term or gradually accumulated changes that might be less significant within a shorter time period.

The periods spanned by values 210 and reference values 212 may further be separated by an adjustable interval to compare data associated with specific events and/or with different baselines or standards. Continuing with the example, values 210 and reference values 212 may be selected from periods separated by one year to compare feature data associated with holidays and/or other yearly events. Values 210 may also, or instead, be compared to multiple sets of reference values 212 from different points in the past (e.g., the last month, the last six months, the last year, etc.) to identify additional trends, shifts, and/or patterns in the corresponding feature distributions.

To compare the distributions of values 210 and reference values 212, monitoring apparatus 202 uses a hypothesis test 208 to calculate a test statistic 214 from values 210 and reference values 212, as well as a statistical significance 216 associated with test statistic 214. For example, monitoring apparatus 202 may use a two-sample Kolmogorov-Smirnov (KS) test to compare the empirical distribution functions of values 210 and reference values 212. Test statistic 214 for the two-sample KS test may be a KS statistic that represents the distance between the empirical distribution functions. Statistical significance 216 may then be calculated using the distance and/or by identifying the quantile of the distance in a distribution of distances calculated from randomly generated data sets. In turn, test statistic 214 and statistical significance 216 may be used to determine if the distributions of values 210 and reference values 212 differ by a statistically significant amount.

The above example may be illustrated using the following. First, the distance produced by the KS test may be represented as:

$${D}_{n , m} = {sup}_{x} \vert {F}_{1 , n} ( x ) - {F}_{2 , m} ( x ) \vert ,$$

Where D_{n,m} represents the KS statistic calculated between two samples (i.e., values 210 and reference values 212), F_{1,n} and F_{2,m} are the empirical distribution functions of the samples, and “sup” is the supremum function. The KS test may have a null hypothesis that the samples are drawn from the same distribution. The null hypothesis may be rejected at a significance level a if, for sizes n and m of the first and second samples:

$${D}_{n , m} > c ( α ) \sqrt{\frac{n + m}{nm}}$$

$$where$$

$$c ( α ) = \sqrt{- \frac{1}{2} ln ( \frac{α}{2} )}$$

To reduce memory and computational resources required to perform hypothesis test 208 with large sample sizes (e.g., millions of values), values 210 and reference values 212 may be converted into histograms prior to calculating test statistic 214 and/or statistical significance 216. The number of bins in the histogram may be selected to ensure adequate sample sizes for comparison by hypothesis test 208. The histograms may optionally be stored in feature repository 234 in lieu of the corresponding values 210 and/or reference values 212 to reduce the amount of storage consumed by feature repository 234 and/or the system.

Monitoring apparatus 202 may further use a distributed parallel-processing technique such as MapReduce to perform the two-sample KS test. First, values 210 and reference values 212 may be sorted and subsequently partitioned. Within each partition, empirical distribution functions are calculated for the partition's subset of values 210 and reference values 212. The empirical distribution functions are then used to determine the minimum distance and maximum distance between the partition's subset of values 210 and reference values 212, and the minimum and maximum distances are tracked along with the number of elements in the partition. After the minimum distance, maximum distance, and number of elements are determined for every partition, the distances in each partition are adjusted by a constant represented by the cumulative sum of the number of elements in the prior partitions divided by the size of the data set (i.e., total number of values 210 and/or reference values 212). The maximum distance from all partitions is then used as the KS statistic for the KS test.

When test statistic 214 and statistical significance 216 indicate a statistically significance difference in the distributions of values 210 and reference values 212, monitoring apparatus 202 may apply a dA-distance test to values 210, reference values 212, and/or the corresponding histograms. In turn, a threshold for the dA-distance test may be selected to identify a subset of histogram bins with the largest differences between the distributions of values 210 and reference values 212.

In one or more embodiments, monitoring apparatus 202 performs hypothesis test 208 on a periodic and/or continuous basis to track changes in the distribution of features from feature repository 234 across sources, platforms, data sets, time intervals, and/or other attributes. For example, monitoring apparatus 202 may perform hypothesis test 208 on a weekly basis to compare the distribution of values 210 from the most recent week with the distribution of reference values 212 from a preceding week.

In turn, management apparatus 204 generates output based on values of test statistic 214, statistical significance 216, and/or other attributes or results associated with hypothesis test 208. First, management apparatus 204 may display and/or otherwise output one or more visualizations 218 associated with the results and/or attributes. For example, visualizations 218 may include tables, spreadsheets, line charts, bar charts, histograms (e.g., histograms of values 210 and reference values 212 overlaid on one another to facilitate identification of differences in the corresponding feature distributions), pie charts, and/or other representations of test statistic 214, statistical significance 216, histograms of values 210 and/or reference values 212, and/or other data associated with hypothesis test 208.

Management apparatus 204 also outputs values 220 associated with the corresponding attributes, within or separately from visualizations 218. For example, management apparatus 204 may display and/or otherwise output values of test statistic 214, statistical significance 216, histogram values associated with values 210 and/or reference value 212, differences in histogram bin counts between values 210 and reference values 212, summary statistics associated with values 210 and/or reference values 212 (e.g., means, medians, variances, percentiles, maximums, minimums, etc.), and/or other attributes.

The output also includes one or more factors 222 that contribute to any deviations in the distribution of the features, as detected by hypothesis test 208 using values 210 and reference values 212. For example, management apparatus 204 may identify platforms, directories, data stores, execution environments, and/or other sources of values 210 and/or reference values 212. In another example, the output may include a hierarchy of features used to generate values 210 and/or reference values 212, as identified using a common feature protocol for defining, organizing, locating, sharing, generating, and/or otherwise using features across execution environments, statistical models, teams, projects, and/or other entities. In a third example, the output may identify specific histogram bins associated with the largest differences between the distributions of values 210 and reference values 212.

Finally, the output may include alerts 224 related to hypothesis test 208, test statistic 214, statistical significance 216, and/or the distributions of values 210 and reference values 212. For example, alerts 224 may be generated in response to statistically significant differences in the distributions of values 210 and reference values 212 and/or deviations in the distributions of values 210 from reference values 212 for a sustained period (e.g., one week, one month, etc.). Alerts 224 may be transmitted via email, notifications, messages, and/or other communications mechanisms to administrators, developers, data scientists, researchers, and/or other users associated with developing and/or maintaining the features and/or statistical models that use the features. As with other types of output generated by management apparatus 204, alerts 224 may include visualizations 218, values 220, factors 222, and/or other data that facilitate assessment and/or management of anomalies in the distributions of features in feature repository 234.

By continuously monitoring and reporting the distribution-level consistency of values 210 and reference values 212, the system of FIG. 2 may quickly detect deviations and/or anomalies in the distributions of features used with statistical models without requiring manual user intervention or analysis of the features or statistical models. Moreover, the use of hypothesis test 208 to compare the distributions at the data set level may produce more accurate results than conventional techniques that use summary statistics and/or performance metrics for statistical models to characterize and/or detect anomalies in the corresponding feature distributions. Consequently, the system of FIG. 2 may improve the performance and use of statistical models and feature-monitoring technologies, along with applications, distributed systems, computer systems, and/or other platforms that use or leverage statistical models and/or features. The system of FIG. 2 may also improve the anomaly detection response time compared with using summary statistics and/or performance metrics, as the latter requires collecting more feature data to model both reference and abnormal distributions.

Those skilled in the art will appreciate that the system of FIG. 2 may be implemented in a variety of ways. First, monitoring apparatus 202, management apparatus 204, and/or feature repository 234 may be provided by a single physical machine, multiple computer systems, one or more virtual machines, a grid, one or more databases, one or more filesystems, and/or a cloud computing system. Monitoring apparatus 202 and management apparatus 204 may additionally be implemented together and/or separately by one or more hardware and/or software components and/or layers. Moreover, various components of the system may be configured to execute in an offline, online, and/or nearline basis to perform different types of processing related to management and monitoring of features and feature sets.

Second, values 210, reference values 212, and/or other data used by the system may be stored, defined, and/or transmitted using a number of techniques. For example, the system may be configured to accept features from different types of repositories, including relational databases, graph databases, data warehouses, filesystems, and/or flat files. The system may also obtain and/or transmit values 210, reference values 212, test statistic 214, statistical significance 216, feature names, features sources, histograms, and/or other data used to monitor or manage features and/or feature distributions in a number of formats, including database records, property lists, Extensible Markup language (XML) documents, JavaScript Object Notation (JSON) objects, and/or other types of structured data.

Third, various techniques may be used to assess the distribution-level consistency of features in feature repository 234. For example, other types of nonparametric and/or hypothesis tests may be used to compare a set of feature values with a set of reference values and/or reference distribution to determine if the distribution of the feature values is consistent with that of the reference. The hypothesis tests may further be selected and/or adapted to assess the distributions of different types of features, such as non-numeric features (e.g., strings, graphs, etc.), binary features, categorical features, multi-dimensional features (e.g., vectors, categorical sets, categorical bags, etc.).

Fourth, the functionality of the system may be adapted to other types of data and/or values associated with machine learning and/or statistical models. For example, the system may be used to compare the distributions of parameters, hyperparameters, and/or performance metrics of statistical models across model versions, different sets of training data, and/or other factors that may affect the training and/or performance of the statistical models.

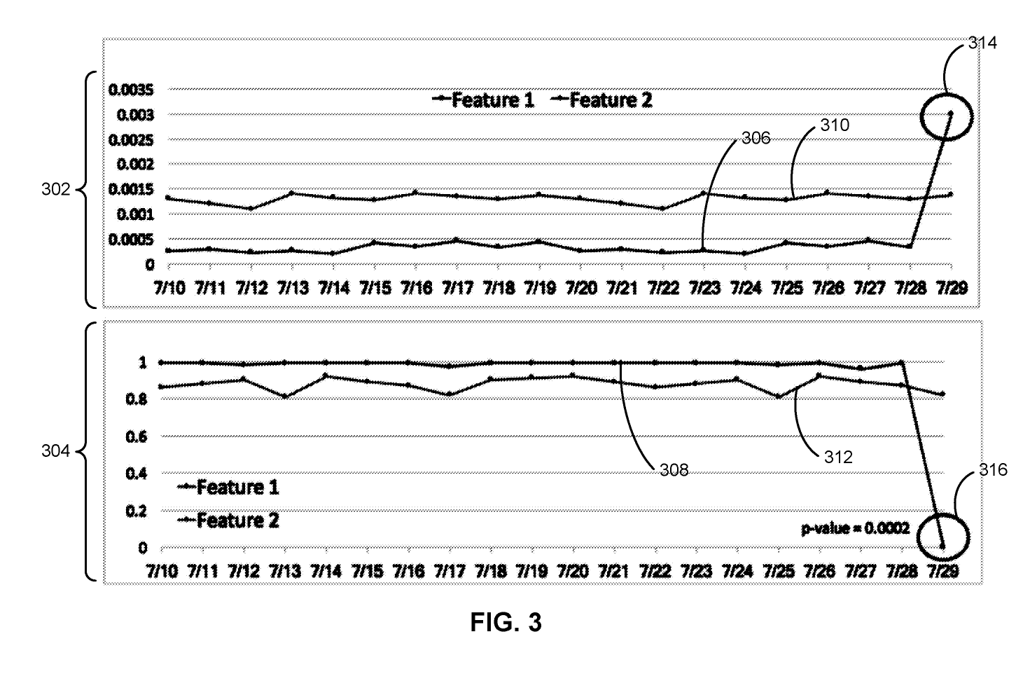

FIG. 3 shows an exemplary screenshot in accordance with the disclosed embodiments. More specifically, FIG. 3 shows a screenshot of a graphical user interface (GUI) provided by a management apparatus, such as management apparatus 204 of FIG. 2. As shown in FIG. 3, the GUI includes a set of visualizations 302-304 associated with two features named “Feature 1” and “Feature 2.”

Visualizations 302-304 include line charts of attribute values associated with the features over time. Visualization 302 includes a plot of a test statistic (e.g., test statistic 214 of FIG. 2) for a hypothesis test (e.g., hypothesis test 208 of FIG. 2) over time, and visualization 304 includes a plot of statistical significance (e.g., statistical significance 216 of FIG. 2) associated with the test statistic over the same period of time. For example, line 306 in visualization 302 may include data points representing values of a KS statistic calculated between a set of values and a corresponding set of reference values of the “Feature 1” feature. Line 310 in visualization 302 may include data points representing values of a KS statistic calculated between a set of values and a corresponding set of reference values of the “Feature 2” feature. Line 308 in visualization 304 may include data points representing p-values associated with the corresponding KS statistic data points in line 306.

Line 312 in visualization 304 may include data points representing a p-value associated with the corresponding KS statistic data points in line 310. Lines 306-312 in visualizations 302-304 are plotted along x-axes with values representing dates, indicating that the corresponding data points are generated on a daily basis (e.g., to detect any distribution differences between the values and reference values on a daily basis).

Lines 306-312 and visualizations 302-304 may be used to identify changes in the corresponding distributions of features over time. For example, point 314 is significantly higher than previous points on line 306, and the corresponding point 316 is significantly lower than previous points on line 312. Points 314-316 may thus indicate a sudden deviation in the distribution of “Feature 1” values from the corresponding reference values. Because the p-value of 0.0002 represented by point 316 falls below a threshold of 0.05 or 0.01, the deviation is considered statistically significant.

By showing test statistics and the corresponding p-values for the distributions of the features in visualizations 302-304, the GUI of FIG. 3 may allow users to track and/or identify patterns in results of the hypothesis test over time and analyze sudden and/or gradual changes in the distributions. For example, lines 306-308 may be used to assess the magnitude and/or suddenness of the change in test statistic and p-value for “Feature 1,” which in turn may assist with determining the root cause of the change and/or responding to the change.

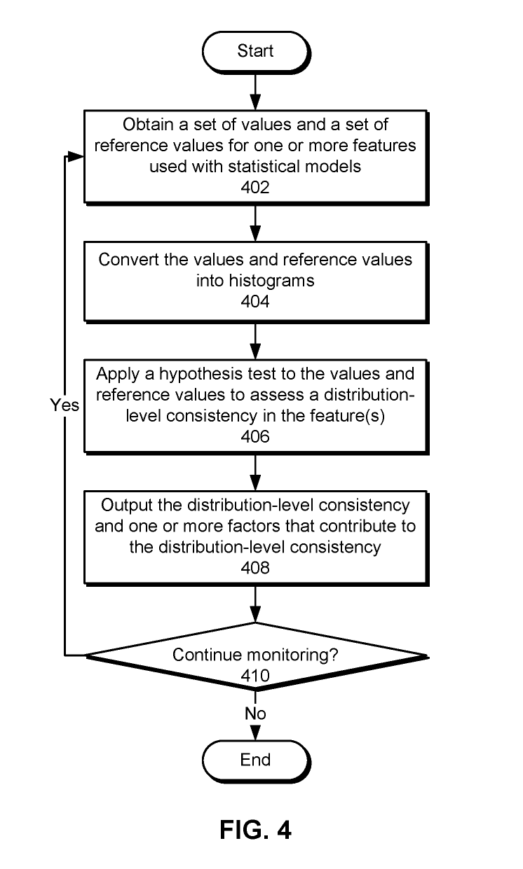

FIG. 4 shows a flowchart illustrating a process of performing distribution-level feature monitoring and reporting in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

Initially, a set of values and a set of reference values for one or more features used with statistical models are obtained (operation 402). The values and reference values may be obtained from different sources, time intervals, and/or data sets. The features may include individual features, multivariate features, numeric features, categorical features, binary features, non-numeric features, and/or other types of features inputted into the statistical models.

Next, the values and reference values are converted into histograms (operation 404). For example, millions of data points for one or more features may be aggregated into histograms of hundreds or thousands of bins to reduce computational and/or memory overhead associated with monitoring the features.

A hypothesis test is then applied to the values and reference values to assess a distribution-level consistency in the feature(s) (operation 406). For example, the hypothesis test may include a two-sample KS test that is applied to the histograms of the values and reference values. The KS test may be used to calculate a test statistic representing the distance between the empirical distribution functions of the values and the reference values. When the test statistic and a corresponding p-value indicate a statistically significant difference between a first distribution of the values and a second distribution of the reference values, a deviation in the first distribution from the second distribution may be found, and a null hypothesis that the two distributions are the same is rejected. If the difference is not statistically significant, the null hypothesis may fail to be rejected.

The distribution-level consistency is outputted with one or more factors that contribute to the distribution-level consistency (operation 408). For example, values of the test statistic, statistical significance, p-value, and/or other results or attributes associated with the hypothesis test over time may be shown in a visualization. The visualization may be accompanied by sources (e.g., data sources, parent features, etc.) of the feature(s) and/or a subset of values that contribute to a lack of the distribution-level consistency in the feature(s) (e.g., one or more histogram bins that contribute most to a deviation in the distribution of a given feature).

Monitoring of the features may continue (operation 410) as the features are generated and/or updated. If monitoring is to continue, operations 402-408 are repeated. For example, the distribution-level consistency of the features may be assessed and reported on a daily, weekly, monthly, and/or other periodic basis to allow anomalies in the distribution of the features to be detected over different time intervals. Such distribution-level monitoring and reporting associated the features may continue until the features are no longer used by the statistical models.

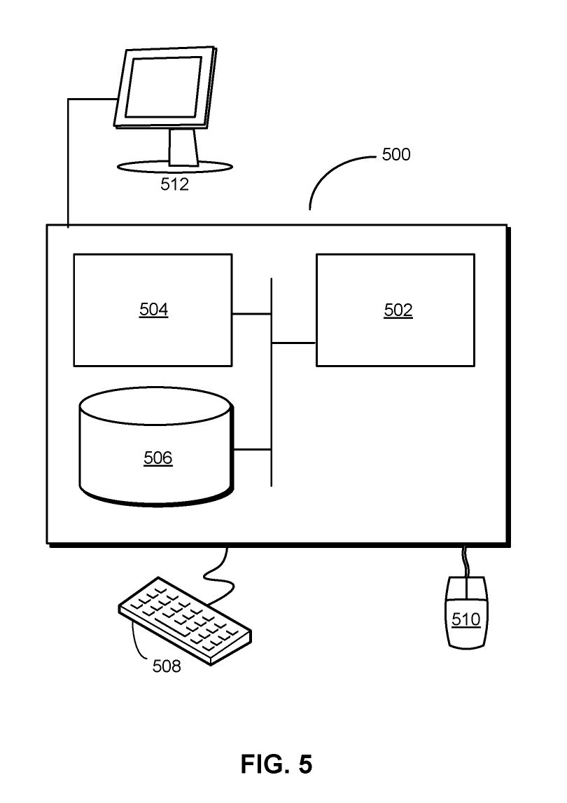

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include a monitoring apparatus and a management apparatus, one or more of which may alternatively be termed or implemented as a module, mechanism, or other type of system component. The monitoring apparatus may obtain a set of values and a set of reference values for one or more features used with one or more statistical models. Next, the monitoring apparatus may apply a hypothesis test to the set of values and the set of reference values to assess a distribution-level consistency in the one or more features. The management apparatus may then output the distribution-level consistency for use in monitoring the distribution of the one or more features. Finally, the management apparatus may include, with the outputted distribution-level consistency, one or more factors that contribute to the distribution-level consistency.

In addition, one or more components of computer system 600 may be remotely located and connected to the other components over a network. Portions of the present embodiments (e.g., monitoring apparatus, management apparatus, feature repository, data-processing system, etc.) may also be located on different nodes of a distributed system that implements the embodiments. For example, the present embodiments may be implemented using a cloud computing system that performs distribution-level monitoring and reporting of features for use by a set of remote statistical models.

By configuring privacy controls or settings as they desire, members of a social network, an online professional network, or other user community that may use or interact with embodiments described herein can control or restrict the information that is collected from them, the information that is provided to them, their interactions with such information and with other members, and/or how such information is used. Implementation of these: embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of values and a set of reference values for one or more features used with one or more statistical models;
applying, by a computer system, a hypothesis test to the set of values and the set of reference values to assess a distribution-level consistency in the one or more features;
outputting the distribution-level consistency for use in monitoring the distribution of the one or more features; and
including, with the outputted distribution-level consistency, one or more factors that contribute to the distribution-level consistency.

2. The method of claim 1, further comprising:
converting the set of values and the set of reference values into histograms prior to applying the hypothesis test.

3. The method of claim 1, further comprising:
periodically applying the hypothesis test to updated versions of the set of values and the set of reference values to reassess the distribution-level consistency in the one or more features.

4. The method of claim 1, wherein applying the hypothesis test to the set of values and the set of reference values to assess the distribution-level consistency in the one or more features comprises:
using the hypothesis test to calculate a test statistic from the set of values and the set of references values; and
when the test statistic indicates a statistically significant difference between a first distribution of the set of values and a second distribution of the set of reference values, identifying a deviation in the first distribution from the second distribution.

5. The method of claim 1, wherein obtaining the set of values and the set of reference values for the one or more features comprises:
obtaining the set of values from a most recent time interval; and
obtaining the set of reference values from a previous time interval.

6. The method of claim 1, wherein obtaining the set of values and the set of reference values for the one or more features comprises:
obtaining the set of values from a first source; and
obtaining the set of reference values from a second source.

7. The method of claim 1, wherein obtaining the set of values and the set of reference values for the one or more features comprises:
obtaining the set of values from unseen data inputted into the one or more statistical models; and
obtaining the set of reference values from training data for the one or more statistical models.

8. The method of claim 1, wherein outputting the distribution-level consistency comprises:
displaying a visualization comprising the distribution-level consistency over time.

9. The method of claim 1, wherein the one or more factors comprise a subset of the values that contribute to a lack of the distribution-level consistency in the one or more features.

10. The method of claim 1, wherein the one or more factors comprise a source of the one or more features.

11. The method of claim 1, wherein the hypothesis test comprises a two-sample Komogorov-Smirnov test.

12. A system, comprising:
one or more processors; and
memory storing instructions that, when executed by the one or more processors, cause the system to:
obtain a set of values and a set of reference values for one or more features used with one or more statistical models;
apply a hypothesis test to the set of values and the set of reference values to assess a distribution-level consistency in the one or more features;
output the distribution-level consistency for use in monitoring the distribution of the one or more features; and
include, with the outputted distribution-level consistency, one or more factors that contribute to the distribution-level consistency.

13. The system of claim 12, wherein the memory further stores instructions that, when executed by the one or more processors, cause the system to:
convert the set of values and the set of reference values into histograms prior to applying the hypothesis test.

14. The system of claim 12, wherein applying the hypothesis test to the set of values and the set of reference values to assess the distribution-level consistency in the one or more features comprises:
using the hypothesis test to calculate a test statistic from the set of values and the set of references values; and
when the test statistic indicates a statistically significant difference between a first distribution of the set of values and a second distribution of the set of reference values, identifying a deviation in the first distribution from the second distribution.

15. The system of claim 12, wherein obtaining the set of values and the set of reference values for the one or more features comprises:
obtaining the set of values from a most recent time interval; and
obtaining the set of reference values from a previous time interval.

16. The system of claim 12, wherein obtaining the set of values and the set of reference values for the one or more features comprises:
obtaining the set of values from a first source; and
obtaining the set of reference values from a second source.

17. The system of claim 12, wherein obtaining the set of values and the set of reference values for the one or more features comprises:
obtaining the set of values from unseen data inputted into the one or more statistical models; and
obtaining the set of reference values from training data for the one or more statistical models.

18. The system of claim 12, wherein the one or more factors comprise a subset of the values that contribute to a lack of the distribution-level consistency in the one or more features.

19. The system of claim 12, wherein the one or more factors comprise a source of the one or more features.

20. A non-transitory computer-readable storage medium storing instructions that when executed by a computer cause the computer to perform a method, the method comprising:
obtaining a set of values and a set of reference values for one or more features used with one or more statistical models;
applying a hypothesis test to the set of values and the set of reference values to assess a distribution-level consistency in the one or more features;
outputting the distribution-level consistency for use in monitoring the distribution of the one or more features; and
including, with the outputted distribution-level consistency, one or more factors that contribute to the distribution-level consistency.
